(19) United States
(12) Patent Application Publication
(10) Pub. No.: US 2016/0213046 A1
(43) Pub. Date: Jul. 28, 2016

(54) METHOD OF MAKING A PEANUT BEVERAGE

(71) Applicant: James Harrell, Suffolk, VA (US)

(72) Inventor: James Harrell, Suffolk, VA (US)

(21) Appl. No.: 14/603,464

(22) Filed: Jan. 23, 2015

(51) Int. Cl. A23L 2/38; A23L 2/52

(52) U.S. Cl. CPC A23L 2/38; A23L 2/52; A23V 2002/00

(57) ABSTRACT

A method of making a peanut beverage provides for roasting a plurality of peanuts, which have been removed from their shells, at a temperature of at least 350° F. It has been found that this temperature produces the required flavor and boldness to place the peanuts more on par with coffee beverages. The temperature generally will be no higher than 550° F. The plurality of peanuts is roasted for at least 8 minutes. Though the ultimately duration of roasting may vary depending on the temperature, typically the roasting will take place over a period of less than about 35 minutes. The term “plurality” has been used herein as there is no set amount of peanuts which may be roasted at any given time.

### BACKGROUND OF THE DISCLOSURE

### Field of the Disclosure

The disclosure relates to beverages and more particularly pertains to a new beverage and process therefore for being consumed in a manner equivalent to the drinking of coffee.

### SUMMARY OF THE DISCLOSURE

An embodiment of the disclosure meets the needs presented above by generally comprising roasting a plurality of peanuts at a temperature of at least 350° F. The plurality of peanuts is roasted for at least 8 minutes. Oil is then removed from the plurality of peanuts and the plurality of peanuts powdered to define a peanut powder. Water is strained through the peanut powder to define a strained liquid that is then consumed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### DESCRIPTION OF THE PREFERRED EMBODIMENT

A new beverage embodying the principles and concepts of an embodiment of the disclosure and generally designated will now described.

The method of making a peanut beverage generally comprises roasting a plurality of peanuts, which have been removed from their shells, at a temperature of at least 350° F. It has been found that this temperature produces the required flavor and boldness to place the peanuts more on par with coffee beverages. The temperature generally will be no higher than 550° F. The plurality of peanuts is roasted for at least 8 minutes. Though the ultimately duration of roasting may vary depending on the temperature, typically the roasting will take place over a period of less than about 35 minutes. The term “plurality” has been used herein as there is no set amount of peanuts which may be roasted at any given time.

After the peanuts have been roasted, the oil, or more particularly, peanut oil, is removed from the plurality of peanuts. This may be accomplished by conventional means such as chemical extraction or mechanical removal with a press. Once the oil has been removed, the plurality of peanuts is made into a fine peanut powder. This may be done by grinding or pulverizing the peanuts using any conventional manner.

Once powderized to define a peanut powder, the peanut powder may be used as would traditional coffee grinds by straining water through the peanut powder. The strained liquid may then be consumed in the normal fashion as either a hot liquid, a cold liquid or as a base for added flavorings.

It may be desired to have caffeine added, either natural caffeine or manufactured caffeine, to the strained liquid. The caffeine may be added at any step in the process beginning with adding the caffeine while the peanuts are still in their shell. However, it may be advantageous to add the caffeine after or during the powderizing process.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A method for making a beverage, said method including the steps of:
roasting a plurality of peanuts at a temperature of at least 350° F., said plurality of peanuts being roasted for at least 8 minutes;
removing oil from said plurality of peanuts;
powderizing said plurality of peanuts to define a peanut powder; and
straining water through said peanut powder to define a strained liquid, said strained liquid being configured to be consumed.

2. The method for making a beverage according to claim 1, wherein the step of roasting a plurality of peanuts includes said temperature being no higher than 550° F.

3. The method for making a beverage according to claim 1, further including the step of adding caffeine to said peanut powder or said plurality of peanuts before straining water through said peanut powder.

4. A method for making a beverage, said method including the steps of:
roasting a plurality of peanuts at a temperature of at least 350° F., said temperature being no higher than 550° F., said plurality of peanuts being roasted for at least 8 minutes and less than 35 minutes;
removing oil from said plurality of peanuts;
powderizing said plurality of peanuts to define a peanut powder;
straining water through said peanut powder to define a strained liquid, said strained liquid being configured to be consumed; and
adding caffeine to said peanut powder or said plurality of peanuts before straining water through said peanut powder.

5. A beverage consisting of:
water being strained through a mixture of powdered roasted peanuts and caffeine, said powdered roasted peanuts being substantially peanut oil free.
